(19) United States
(12) Patent Application Publication
(10) Pub. No.: US 2009/0057069 A1
(43) Pub. Date: Mar. 5, 2009

(54) Elevator information display and security monitor system

(76) Inventor: Charles H. Boggess, Lake Oswego, OR (US)

Correspondence Address: ATER WYNNE LLP, 222 SW COLUMBIA, SUITE 1800, PORTLAND, OR, 97201-6618, US

(21) Appl. No.: 12/229,642

(22) Filed: Aug. 25, 2008

Related U.S. Application Data
(60) Provisional application No. 60/966,026, filed on Aug. 24, 2007.

(51) Int. Cl. B66B 3/00; G09F 27/00

(52) U.S. Cl. 187/392; 340/540; 187/396

(57) ABSTRACT

A dynamic display and monitor system for use in or near an elevator includes a display mechanism mounted proximate an elevator landing, the display mechanism including a video monitor; a player mechanism remote from and operatively connected with the display mechanism, the player mechanism configured to feed substantially continuous visual content to the video monitor for display thereon; and an Internet-based server mechanism operatively coupled with the player mechanism over the Internet for programming the visual content for feeding by the player mechanism to the video monitor of the display mechanism. An in-elevator cab infotainment and security system includes a display configured for wireless operative coupling with a remote server, the display being configured further to present viewable infotainment content to a viewer riding in the elevator cab, and a security camera configured for wireless operative coupling with a remote server, the camera capturing digital imagery of a substantial portion of the elevator cab interior for remote security monitoring, the display and camera being mounted within an enclosure configured to mount within an interior region of an elevator cab, the display and the camera being operatively coupled to a remote server via the Internet.

### RELATED APPLICATIONS

This application claims the benefit of priority to U.S. Provisional application No. 60/966,026, filed on 24 Aug. 2007 and entitled PARKING GARAGE ELEVATOR DYNAMIC DISPLAY AND MONITOR SYSTEM, the contents of which are hereby incorporated herein in their entirety by this reference.

### FIELD OF THE INVENTION

This invention relates generally to the field of entertainment and security within parking garages and/or high-rise buildings. More particularly, it concerns providing illumination and activity in the form of multimedia news, education, music, entertainment, and/or advertising to persons waiting in or traversing such areas: who heretofore typically have been idle, bored, vexed, and/or vulnerable.

### BRIEF DESCRIPTION OF THE DRAWINGS

FIG. 1 is a schematic block diagram of the parking garage elevator and landing display and monitor system in accordance with one embodiment of the invention.

FIGS. 2A-2C are screen grabs illustrating various typical display contents and organizations of the display and monitor system of FIG. 1. Specifically, FIG. 2A shows a mosaic of four concurrent freeway traffic video feeds as well as a “Times Square”-type or “crawl” news highlights feed across a bottom region of the screen. FIG. 2B shows a regional weekly weather forecast, also with a crawl. FIG. 2C schematically illustrates a local advertisement playing in the large uninterrupted area of the screen, with a crawl at the bottom.

FIGS. 3A and 3B are exploded assembly drawings of a typical on-landing display and speaker monitor enclosure and a typical in-elevator display and speaker monitor enclosure, respectively.

FIG. 4 is a system block diagram showing the information display and security monitor system in accordance with a second embodiment of the invention.

### DETAILED DESCRIPTION OF THE PREFERRED EMBODIMENTS

The invention in accordance with a preferred embodiment involves providing a parking garage's subterranean elevators and attendant landings with multimedia displays inside and out for a seamless audiovisual feed to awaiting or traversing elevator passengers to inform, educate and entertain their otherwise idle existence. Optionally, security monitor cameras and audiovisual recordings are provided of the same areas for parking lot and/or building maintenance/management oversight and safety assurance. The elevator cab displays and/or cameras derive power from the elevator cab's electrical “umbilical cord”, thus further reducing any possible interference with elevator safety. The entire multimedia feed/display system is wireless, thereby obviating regulatory compliance requirements that govern elevators and other safety corridors. Unique elevator cab-based antennae can be provided to ensure multimedia data integrity and audio-visual quality of the display and camera feeds in the case of plural-cab elevator shaft installations.

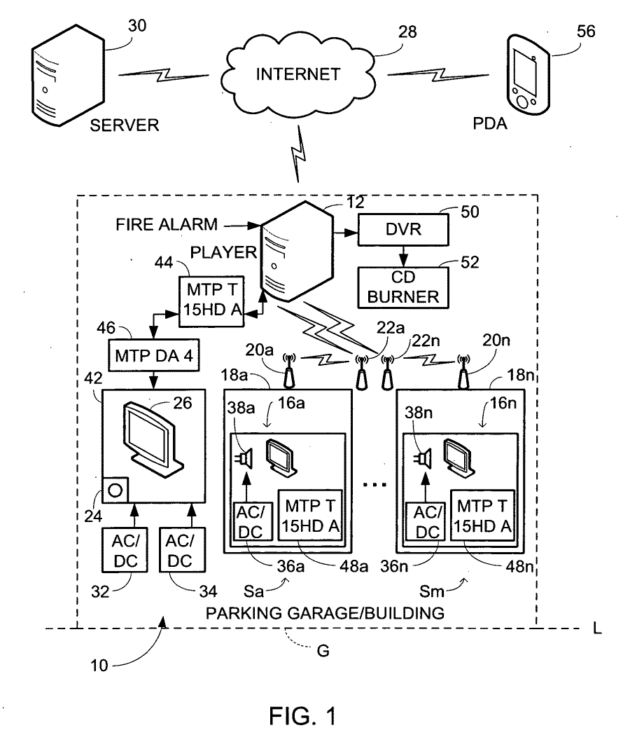

FIG. 1 illustrates in block diagram form the invented system 10. System 10 includes a player 12 including a transmitter 14 in a garage G and plural display subsystems 16a, . . . 16n located within one or more elevator cabs 18a, . . . 18m (wherein n>m typically) and on a landing L at the base of one or more corresponding elevator shafts Sa, . . . Sm. All of the elevator-based display subsystems 16a, . . . 16n are operatively and wirelessly coupled with player 12. Display subsystems 16a, . . . 16n each include a receive-only antenna 20a, . . . 20n, and shafts Sa, . . . Sm each include a transmit/receive antenna 22a, . . . 22n. System 10 optionally includes one or more digital cameras such as digital camera 24 operatively coupled with one or more monitors such as monitor 26 located also in landing L within in garage G adjacent the one or more elevator shafts Sa, . . . Sm.

Those of skill in the art will appreciate that one or more special transmit/receive and receive-only antennae might be used in connection with elevator shafts having multiple elevator cabs therein. Antennae having higher sensitivity and perhaps also higher selectivity (narrower and sharper band-pass) are useful in such contexts to reduce the possibility of interference between multiple signals being concurrently transmitted and received within the plural-cab elevator shafts. Those of skill in the art will also appreciate that receive only antenna 20 and transmit-receive antenna 22 described above for use in single-cab elevators generally do not require such high-Q performance.

In accordance with one embodiment of the invention, display subsystems 16a, . . . 16n and display 26 include high-resolution (e.g. 1024×768 XGA) LCD display monitors of different sizes (e.g. ˜10″ for the in-elevator displays and ˜15″ for the on-landing display) available from Planar Systems, Beaverton, Oreg., USA. These are operated by simple and standard (shielded) cabling from receive-only antenna 20 using standard hardware connections and DC power. Alternative display monitors are contemplated as being within the spirit and scope of the invention.

Those of skill in the art will appreciate that the player drives the display subsystems with pre-programmed or ‘canned’ viewable content for viewing by elevator passengers and that, optionally, a security guard surveys the elevator landings via the monitor in real time to ensure the safety of the elevator passengers and the integrity of the garage. Digital camera 24 and monitor 26 can be wired or wireless devices, as are known, but in accordance with one embodiment of the invention, at least the monitor connection within the elevator shaft is wireless. The use in the garage of such security monitoring can reduce liability insurance costs for the building or parking lot owner or operator. Thus, in accordance with one embodiment of the invention, the broadcast to the in-elevator displays (at least) is accomplished wirelessly, e.g. using the industry-standard 802.11 protocol.

Those of skill in the art will appreciate that elevators and other safety corridors in some states are regulated and compliance checked to ensure that nothing within an elevator shaft can interfere with the elevator cab's operation. For this and technology reasons, displays have not found their way into most elevators. By rendering the invented elevator cab-based display subsystem wireless, compliance with safety regulations is assured and passengers are able to view seamless audio-visual content as they wait outside an elevator and as they ride the elevator. Local and/or national advertising, local and/or syndicated television news programming, educational information and/or entertainment can be provided in one or more larger single or plural display regions and/or in smaller so-called “crawl” or “Times Square”-type display regions of each display subsystem's screen, as will be seen.

In accordance with one embodiment of the invention, player 12 is coupled to the Internet 28. An administrative server 30 is provided for programming, editing and monitoring the client player to affect a stored playlist of content that player 12 broadcasts to the display subsystems via the antennas. Those of skill in the art will appreciate that this permits a remote administrator to change the playlist at will and in real time to update advertiser lists, advertiser content, RSS feeds, and other viewable source audiovisual material provided to the display subsystems.

Thus, the invented system provides dynamic content easily programmable in real-time response to changing advertiser lists, consumer preferences, facilities managers, etc. Such dynamic program can be programmed from a remote location, as by a cell phone, personal digital assistant (PDA), laptop, desktop computer, or other suitable telecommunications-capable device that is logged into an administration server connected in turn over the Internet to a player. By a simple update to a playlist, for example, the content on one or more facilities' display monitors can be instantaneously changed. The content readily can be changed also in real time by the source or supplier or feeder of the content, as will be appreciated by those of skill in the art, in the case of live feeds over simple conveyances and protocols, e.g. industry-standard Really Simple Syndication (RSS).

FIG. 1 also illustrates power conversion and distribution within invented system 10. System 10 includes two power converters 32 and 34 that supply DC power to the landing-based display subsystems, digital cameras and to various Extron twisted pair cable transmitter and receiver devices. System 10 further includes power converters 36a, . . . 36n that supply DC power to corresponding audio subsystems 38a, . . . 38n within each elevator cab. Converters 32 and 34 covert 110VAC to 12VDC whereas converters 36a, . . . 36n convert 110VAC to 24VDC. (Those of skill in the art will appreciate that AC power is derived from the landing or elevator, respectively.) These DC power connections are fused in accordance with one embodiment of the invention. Those of skill in the art will appreciate that audio subsystems 38a, . . . 38n each can include a Radio Design Labs (RDL) DC amplifier or equivalent device (not shown) that controls the volume of a speaker, all located within corresponding enclosures 40a, . . . 40n surrounding the display subsystem and preferably utilizing a daisy-chained wiring harness that also supplied the display. Landing-based camera 24 and display monitor 26 (preferably also with a high-fidelity speaker subsystem (not shown in FIG. 1) are housed neatly within an enclosure 42.

An Extron MTP T 15HD A device 44 near player 12 and a corresponding Extron MTP DA 4 device 46 near each landing L route audio and video content from player 12 to display subsystem at each elevator landing. Elevator cabs 18a, . . . 18n also include Extron MTP T 15HD A devices 48a, . . . 48n within corresponding enclosures 40a, . . . 40n to receive and split the audiovisual signal received at receive-only antennae 20a, . . . 20n. Device 44 also routes audiovisual content to an Avocent wireless transmitter for transmission to receiver/transmitter antennae 22a, . . . 22n within each elevator shaft Sa, . . . Sm, as shown. Operatively coupled with camera 24 and/or monitor 26 and/or player 12 (and located preferably near player 12) there can be included a 4-, 8- or 16-channel digital video recorder (DVR) 50 equipped with a CD burner 52 for recording and archiving security camera imagery.

A unique audio feature forms another part of the invention. Ambient noise on landing L can be overcome by auto-elevating the volume when the noise level is above a determined threshold amount. This can easily be implemented in software implemented in player 12, so that a volume control signal is automatically generated and sent to the RDL volume control device associated with the speaker assembly associated with display 26 within enclosure 42. Such ambient noise level detection is straightforward, and can be a simple broadband pass filter and suitably biased operational amplifier or equivalent circuit.

A unique safety feature forms yet another part of the invention. In the event of fire (or other hazard) in the building housing the invented display and monitor system, an over-ride of the display's screen is provided as a safety measure. The over-riding screen warns elevator riders of the detection of a fire, and informs riders how to safely exit the elevator and the building for approximately fifteen seconds following an emergency, e.g. fire, alarm from the garage facility. In accordance with one embodiment of the invention, the fire warning screen is a simple, static frame bearing instructions, the display of which replaces whatever the existing display was when the fire was detected. It can be a part of the canned programmed, player-based content, and can be automatically invoked and displayed by the player software or it can prompt a double-check by a local building safety coordinator, who in turn gives the player a command to so-override the normal display at least within the elevators with the fire safety warning and instructions for the safety of the riders. This feature is illustrated by a FIRE ALARM input directed to player 12 in FIG. 1.

Suitable alternatives to the configuration of devices of course are contemplated as being within the spirit and scope of the invention. For example, for longer elevator landing or shaft installations, e.g. for distances over 1000 feet, an Extron. MTP RT HD or Minicom device may be used instead of the MTP T 15HD A devices. Other devices alternatively can be used, within the spirit and scope of the invention.

Accordingly, those of skill in the art will appreciate that alternative hardware configurations are contemplated as being within the spirit and scope of the invention. For example, the number, make, and model of components and their configuration within the garage and elevator landings, shafts and cabs can be different. The components can be specified to operate differently from those described and illustrated herein. Different interconnections or enclosures can be used. All within the spirit and scope of the invention.

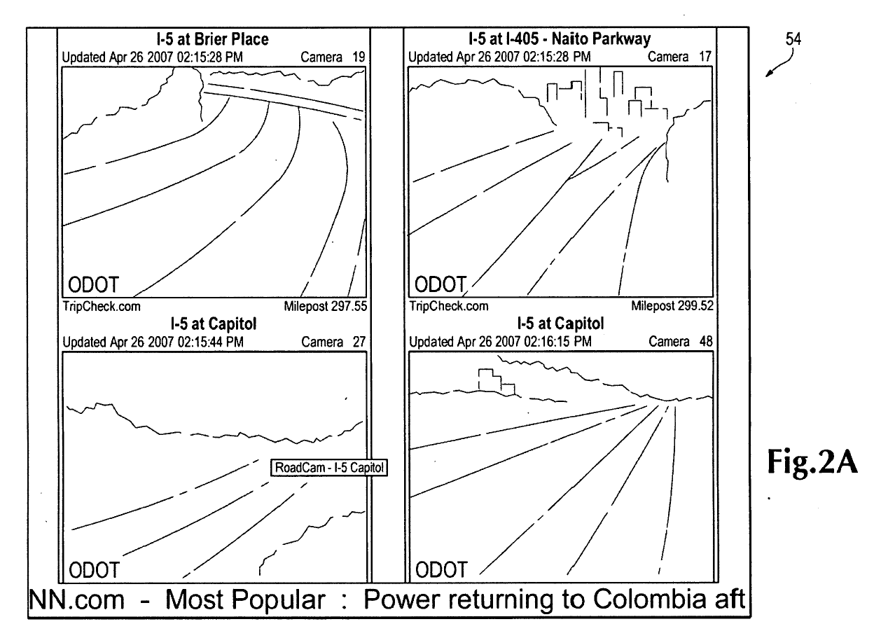

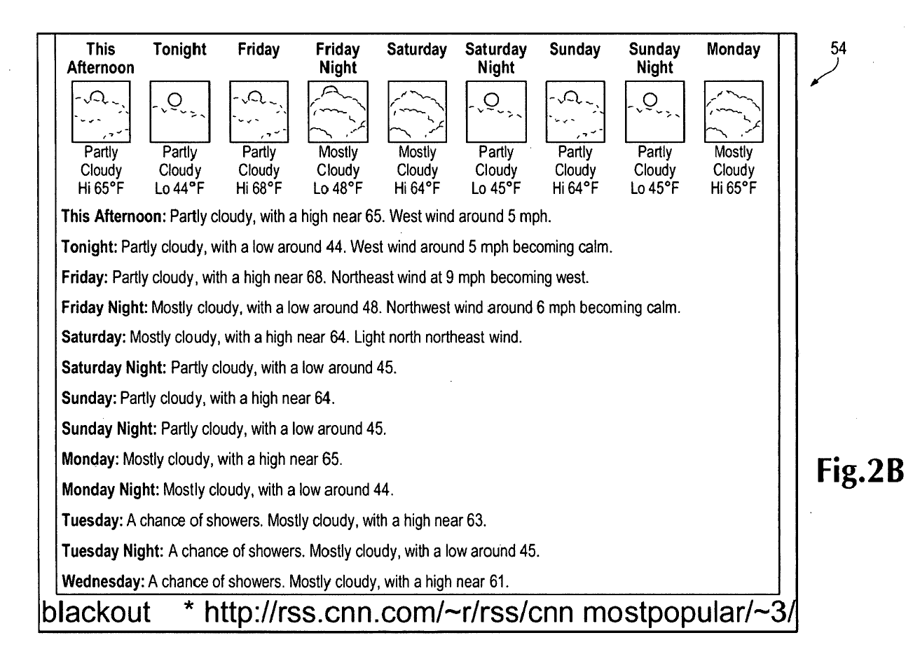

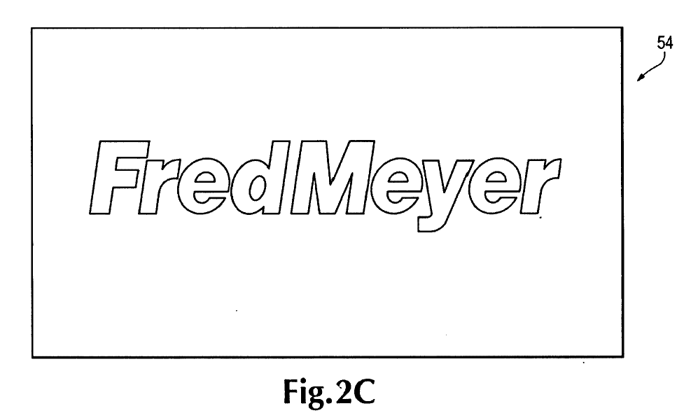

FIGS. 2A through 2C illustrate typical screen 54 contents and organizations within display subsystem 16. Those of skill in the art will appreciate that the invention is not limited by the content of the feeds or screens displaying it. Thus, any content is contemplated as being within the spirit and scope of the invention.

FIG. 2A shows a quad (containing four rectangular sub-regions) mosaic arrangement of live Oregon Department of Transportation (ODOT) camera views of key freeway environs around Portland, Oreg., USA. FIG. 2A also shows a crawl or Times Square-type display across a more confined bottom region of the screen. The camera views represent four concurrent views of four key I-5 intersections, and convey to the viewer traveling in an elevator or waiting on a landing what to expect traffic-wise, and perhaps how to avoid traffic congestion on the way home. Meanwhile, at a glance, the viewer can also get a quick update on power restoration to the Columbia.

FIG. 2B shows a weekly weather forecast for Portland, Oreg., USA, with graphics and descriptive text for each day and night of the week. The forecast thus conveys to the viewer awaiting or riding an elevator what to expect weather-wise, and perhaps whether to deploy an umbrella. Meanwhile, also at a glance, the viewer can get an update on the status of a blackout.

FIG. 2C depicts a screen grab from a local, e.g. FRED MEYER™, commercial advertisement playing over the major portion of the screen, the display broken only slightly by a Times Square or crawl insert along the bottom showing breaking national or local news. Meanwhile, also at a glance, the viewer can get a URL for a developing story, perhaps to browse during the MAX ride home.

Those of skill in the art will appreciate that the illustrated contents and organizations are illustrative only of myriad possibilities, all within the spirit and scope of the invention. The dynamic feed possibilities enabled by the invention render the content free-form and changeable to satisfy riders/standers' preferences and advertisers' rating goals and parking garage or facilities managers' or owners/operators' revenue or public service aspirations. In accordance with the invention, then, programming of content can be accomplished in real time from a remote location. Notably, an over-ride display content can be used in-elevator and/or on-landing to alert riders of a fire and to instruct them regarding safe evacuation based very simply but cleverly on fire alarm detection that typically is a part of every public or private building's safety infrastructure. Thus, dynamically changing content of an individual display/speaker, a group of displays/speakers can be controlled remotely in real time via an Internet-connected PDA 56 or equivalent portable or desktop device, as illustrated in FIG. 1.

Navori Tycoon™ software executing on such a remote PDA, laptop or desktop computer can be used to script (program), update (edit), and organize content on one or more instances of player 12 that feeds one or more of screens 54. The software permits content to be selected from a library of content that might include weather, long range forecast, traffic, local events, breaking news, entertainment, advertisements, fire warnings, etc. It does so with a user-friendly graphic user interface (GUI) providing pop-up and pull-down menus and functions for drag-n-drop insertion of content from various sources. Its scripting software permits the user to include graphics, slide shows, video streams, media clips, RSS feeds, mosaics, and/or crawls, and to define or shuffle (pseudo-randomize) the order of the playlist. Those of skill will appreciate that alternative software and functionality can be used to select, organize and order content for viewing on screens 54, within the spirit and scope of the invention.

Accordingly, those of skill in the art will appreciate that an owner or licensee of the invention might subscribe advertisers for a particular installation, e.g. a parking garage, obtaining audiovisual (A/V) content from one or more advertisers in any suitable form such as a .mpg or .wmv (or other A/V formatted) file, CDROM, DVD or the like. The owner or licensee's designated scriptwriter or ‘ad-master’ might then script a continuous A/V program of rotating advertisements featuring the provided content. Such can be done remotely from the server by way of a PC, desktop computer, PDA or the like, and the feed for a particular installation can be edited at will by an authorized person. The air-ready playlist or scripted content can be uploaded to the server and can be ‘on-the-air’ in a matter of seconds or minutes. Importantly, some or all of the content can be dynamic, e.g. a live- or web-cast of a busy intersection provided by a city's transportation department, e.g. ODOT, to increase the currency of its embedded information content. Those of skill in the art will appreciate that the content being viewed by a rider of an elevator or a person awaiting arrival of an elevator can be made to be seamless flow of local, regional, national, or global information or entertainment, so-called ‘infotainment.’ Those of skill in the art also will appreciate that the owner or licensee can obtain advertisement play time-based revenue from the advertisers (and perhaps also revenue from the building or garage's owner/operator) to pay for installation and maintenance.

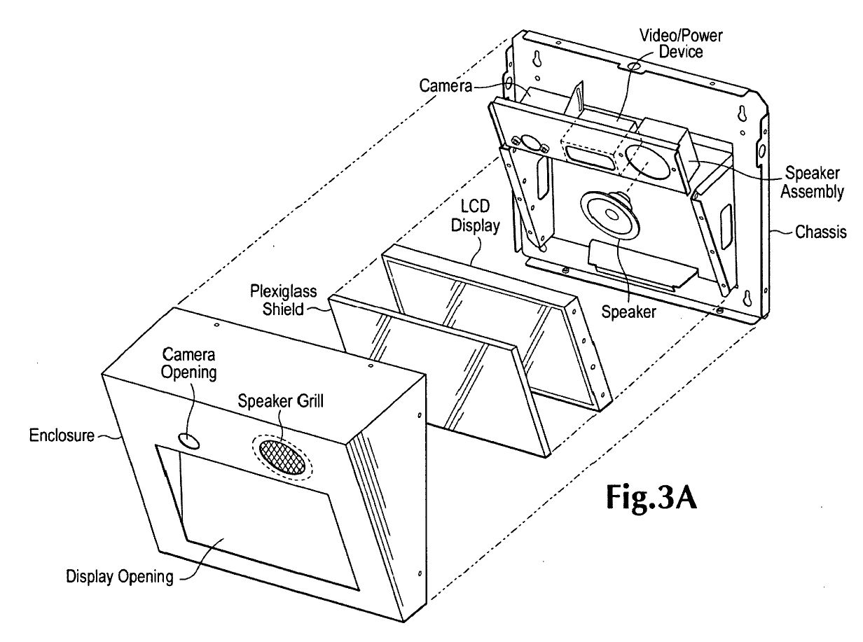

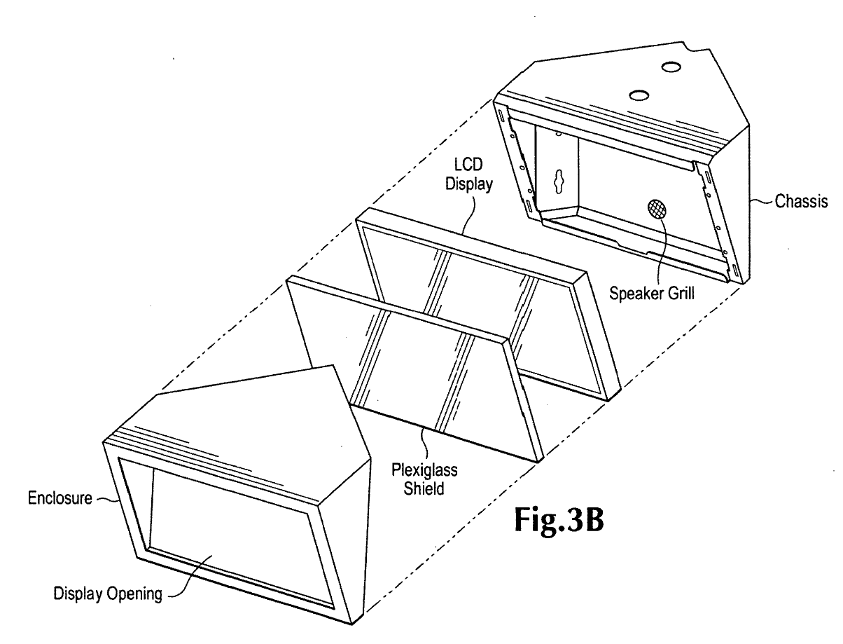

FIGS. 3A and 3B are exploded assembly diagrams respectively illustrating a typical on-landing display and speaker monitor enclosure and a typical in-elevator display and speaker monitor enclosure. The assembly drawings are believed to be self-explanatory, as they illustrate a wireframe and polycarbonate or polystyrene molded cover, along with the electronic components housed therein. Importantly, both enclosures include a thick, durable fiberglass LCD monitor shield to resist wear and/or damage to the relatively expensive and otherwise vulnerable display screens.

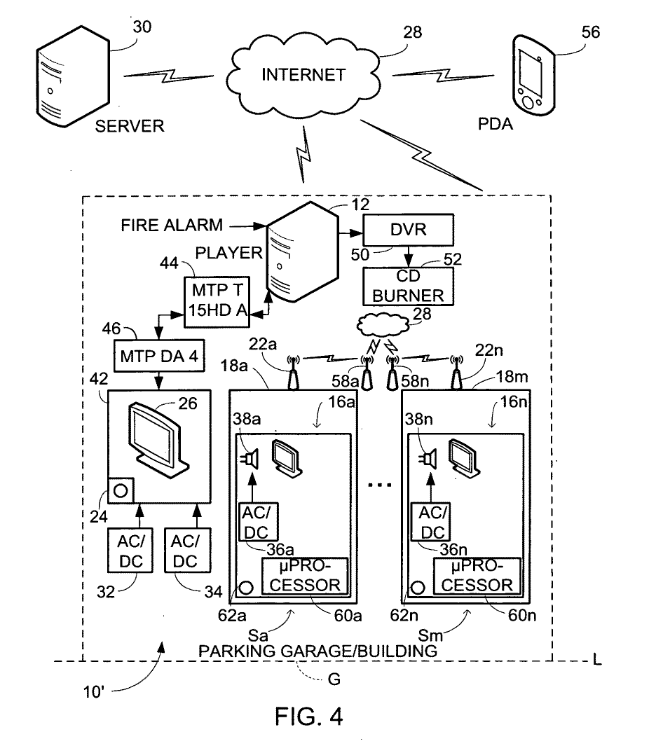

FIG. 4 schematically illustrates an alternative embodiment of invented system 10′. Those of skill will appreciate that, as between FIGS. 1 and 4, identical blocks are identically reference designated, and that similar blocks are similarly reference designated, e.g. by adding a prime symbol (′) as a suffix. For the sake of brevity, the description below of system 10′ in FIG. 4 will not repeat the detailed description above of functions and components that it has in common with system 10 in FIG. 1.

System 10′ will be understood further to include shaft-mounted wireless access points (WAPs) 58a . . . 58n for most if not all elevator shafts Sa . . . Sm; a microprocessor 60a . . . 60n for most if not all elevator cabs 18a . . . 18m within the shafts; and security cameras 62a . . . 62n (akin to landing L-based security camera 24) for most if not all elevator cabs 18a . . . 18m within shafts Sa . . . Sm. Those of skill will appreciate that the microprocessors are DC powered and may be packaged as microcomputers typically including a microprocessor, read-only memory (ROM), read-and-write memory (RAM), a printed circuit board (PCB), and input/output (I/O) ports (not shown). Those of skill also will appreciate that the microprocessors (which, in accordance with this embodiment of the invention, are understood effectively to replace Extron MTP T 15HD A devices 48a, . . . 48n shown in FIG. 1) can run Typhoon player software as does player 12 to enable it to connect to the Internet 28 and to feed audiovisual infotainment content or information to the cab-mounted display from server 30 for information and entertainment purposes and to feed audiovisual security content or information in the form of digital imagery from the security camera to the server for security archiving purposes.

Those of skill in the art will appreciate that the use of wireless, e.g. 802.11, communication between antennas 22a . . . 22n and corresponding WAPs 58a . . . 58n, and the use of Internet 28 provides unprecedented noise immunity to a generally noisy elevator shaft and cab environment. Those of skill also will appreciate that such omits wiring harnesses extending within elevator shafts Sa . . . Sm, thereby avoiding or obviating safety and regulatory prohibitions or guidelines.

From the foregoing, those of skill in the art will appreciate that several advantages of the present invention include the following.

The present invention provides an elevator passenger with interesting audiovisual content seamlessly as they await and ride in an underground garage or parking lot or high-rise elevator. It permits remote selection and organization of audiovisual contents over the Internet for real-time responsiveness to a new advertiser, different content availability, and/or emergency. Those of skill in the art will appreciate that a file transfer protocol- (FTP-) equipped server 30 may be required to perform the send/play functions required of player 12. It also provides more security via the digital camera and DVR/CD burner/monitor surveillance subsystem. It operates wirelessly and compatibly with safety corridor regulations. It gives a rider a sense of purpose and community in an otherwise lone and sometimes desolate and occasionally scary environment.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the spirit and scope of the invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that the method, system and apparatus of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

I claim:

1. A dynamic display and monitor system for use in or near an elevator, the system comprising:
a display mechanism mounted proximate an elevator landing, the display mechanism including a video monitor;
a player mechanism remote from and operatively connected with the display mechanism, the player mechanism configured to feed substantially continuous visual content to the video monitor for display thereon; and
an Internet-based server mechanism operatively coupled with the player mechanism over the Internet for programming the visual content for feeding by the player mechanism to the video monitor of the display mechanism.

2. The system of claim 1, wherein the display mechanism and the player mechanism are operatively coupled to one another via a hard-wired connection.

3. The system of claim 1, wherein the display mechanism and the player mechanism are operatively coupled to one another wirelessly.

4. The system of claim 1 further comprising:
a portable digital processor mechanism operatively coupled with the Internet and with the server, the processor mechanism including a user interface, the user interface including scripting software, the scripting software enabling a user remotely to script visual content for display on the video monitor.

5. The system of claim 1 further comprising:
a second display monitor mounted within an elevator cab, the second display monitor being operatively coupled with the server, the display monitor displaying the same visual content as that displayed by the first display monitor.

6. The system of claim 5, wherein the visual content of the first and second display monitors is synchronized in time to enable seamless viewing by a viewer transitioning from the elevator cab to the landing or vice versa.

7. The system of claim 6, wherein the second display monitor is operatively coupled to the server wirelessly.

8. The system of claim 6, wherein the second display monitor is operatively coupled to the server via the Internet.

9. The system of claim 8, wherein the display mechanism includes an elevator cab-mounted antenna and a microcomputer within the elevator cab, the microcomputer configured to execute player software capable of establishing a connection via the antenna and via an elevator shaft-mounted wireless access point (WAP) to the server over the Internet.

10. The system of claim 9, wherein the connection between the antenna and the WAP is wireless.

11. The system of claim 8 in which the content is audiovisual, wherein the display mechanism further includes a speaker.

12. The system of claim 8, wherein the display mechanism further includes a security camera operatively coupled with the microcomputer for recording digital imagery and for conveying the same to the remote server.

13. The system of claim 8 further comprising:
an alarm mechanism responsive to a facilities alarm input, the alarm mechanism operatively coupled with at least one of the first and second display monitors to at least partially over-ride the content within a visual indication of the alarm input.

14. An in-elevator cab infotainment and security system comprising:
a display configured for wireless operative coupling with a remote server, the display being configured further to present viewable infotainment content to a viewer riding in the elevator cab, and
a security camera configured for wireless operative coupling with a remote server, the camera capturing digital imagery of a substantial portion of the elevator cab interior for remote security monitoring,
the display and camera being mounted within an enclosure configured to mount within an interior region of an elevator cab,
the display and the camera being operatively coupled to a remote server via the Internet.

15. The system of claim 14 in which the server is Internet-based, wherein the operative wireless couplings also are Internet-based.

16. The system of claim 15 further comprising:
an elevator cab-mounted antenna; and
an elevator shaft-mounted wireless access point (WAP).

17. The system of claim 16, wherein the antenna and the WAP are operatively wirelessly coupled with one another.

18. The system of claim 17 further comprising:
a microprocessor operatively coupled with the display, the security camera, the antenna, and the WAP, the microprocessor configured to establish a connection via the antenna and via the WAP to the server over the Internet, the established connection enabling an audiovisual feed from the server to the display and an audiovisual feed from the camera to the server.

19. The system of claim 18, wherein the audiovisual feed from the server to the display includes content chosen from one or more of weather conditions, weather forecast, traffic conditions, local events, breaking news, entertainment, advertisements, and facility over-ride warnings for informational and entertainment purposes.

20. The system of claim 19, wherein the audiovisual feed from the camera to the server includes date-and-time-stamped digital imagery of the interior of the elevator cab for security archiving purposes.
